(19) United States
(12) Patent Application Publication
(10) Pub. No.: US 2013/0326364 A1
(43) Pub. Date: Dec. 5, 2013

(54) POSITION RELATIVE HOLOGRAM INTERACTIONS

(71) Applicants: Stephen G. Latta, Seattle, WA (US); Adam G. Poulos, Redmond, WA (US); Daniel J. McCulloch, Kirkland, WA (US); Wei Zhang, Redmond, WA (US)

(72) Inventors: Stephen G. Latta, Seattle, WA (US); Adam G. Poulos, Redmond, WA (US); Daniel J. McCulloch, Kirkland, WA (US); Wei Zhang, Redmond, WA (US)

(21) Appl. No.: 13/485,511

(22) Filed: May 31, 2012

(51) Int. Cl. G06F 3/048

(52) U.S. Cl. 715/751

(57) ABSTRACT

A system and method are disclosed for positioning and sizing virtual objects in a mixed reality environment in a way that is optimal and most comfortable for a user to interact with the virtual objects.

### BACKGROUND

Mixed reality is a technology that allows virtual imagery to be mixed with a real world physical environment. A see-through, head mounted, mixed reality display device may be worn by a user to view the mixed imagery of real objects and virtual objects displayed in the user's field of view. A user may further interact with virtual objects, for example by performing hand, head or voice gestures to move the objects, alter their appearance or simply view them. As a user moves around within a physical environment, the user's position relative to the virtual objects changes, often making it difficult or impossible to interact with virtual objects from off-angles.

### SUMMARY

Embodiments of the present technology relate to a system and method for positioning and sizing virtual objects, also referred to as holograms, in a mixed reality environment in a way that is optimal and most comfortable for a user to interact with the virtual objects. A system for creating a mixed reality environment in general includes a see-through, head mounted display device coupled to one or more processing units. The processing units in cooperation with the head mounted display unit(s) are able to determine the user's position and where the user is looking in the physical environment. The processing units are also able to determine one or more objects with which a user is interacting, either through inference or express physical or verbal gestures of the user.

Using this information, the mixed reality system is able to optimize the position and size of one or more virtual objects with which the user is interacting. Virtual objects, such as virtual display slates providing content to the user, may be moved, rotated and/or resized so as to remain in positions that are optimal and most comfortable for user interaction.

In an example, the present technology relates to a system for presenting a mixed reality experience to one or more users, the system comprising: one or more display devices for the one or more users, each display device including a display unit for displaying a virtual image to the user of the display device; and a computing system operatively coupled to the one or more display devices, the computing system generating the virtual image for display on the one or more display devices, the computing system displaying the virtual image to a user of the one or more users at positions where the virtual object remains accessible to the user for interaction with the virtual object by the user as the user's head position changes.

In another example, the present technology relates to a system for presenting a mixed reality experience to a user, the system comprising: a display device for the user, the display device including a first set of sensors for sensing data relating to a position of the display device and a display unit for displaying a virtual image to the user of the display device; and a computing system operatively coupled to the display device, the computing system including a second set of sensors for sensing data relating to a position of the user, and the computing system generating the virtual image for display on the display device, the computing system displaying the virtual image to the user at positions in three-dimensional space that, over a predetermined period of time, average to a constant position within the user's field of view as the user moves.

In a further example, the present technology relates to a method of presenting a mixed reality experience to one or more users, the method comprising: (a) displaying a static virtual object to a user at a first position in the user's field of view; (b) displaying a dynamic virtual object to the user at a second position in the user's field of view; (c) displaying the static virtual object to the user at a third position in the user's field of view upon movement of the user; and (d) displaying the dynamic virtual object to the user at the second position in the user's field of view of said step (b) upon the movement of the user in said step (c).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a mixed reality environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the components of a hub computing system used with head mounted display unit.

FIG. 7 is a block diagram of one embodiment of a computing system that can be used to implement the hub computing system described herein.

FIG. 8 is an illustration of an example of a mixed reality environment including a display of a virtual object which remains accessible in the user's FOV as the user moves around.

FIG. 9 is a flowchart showing the operation and collaboration of the hub computing system, one or more processing units and one or more head mounted display units of the present system.

FIGS. 10-13A are more detailed flowcharts of examples of various steps shown in the flowchart of FIG. 9.

FIG. 14 is an illustration of an example of a mixed reality environment including display of a virtual object which has moved with a user to remain accessible in the user's FOV.

FIGS. 15 and 16 show an exemplary field of view where a virtual object has moved as a user has turned his head so that the virtual object remains stationary within the user's FOV.

FIG. 17 is an illustration of an example of a mixed reality environment including display of a virtual object displaying two-dimensional or stereoscopic content which remains accessible in the user's FOV.

### DETAILED DESCRIPTION

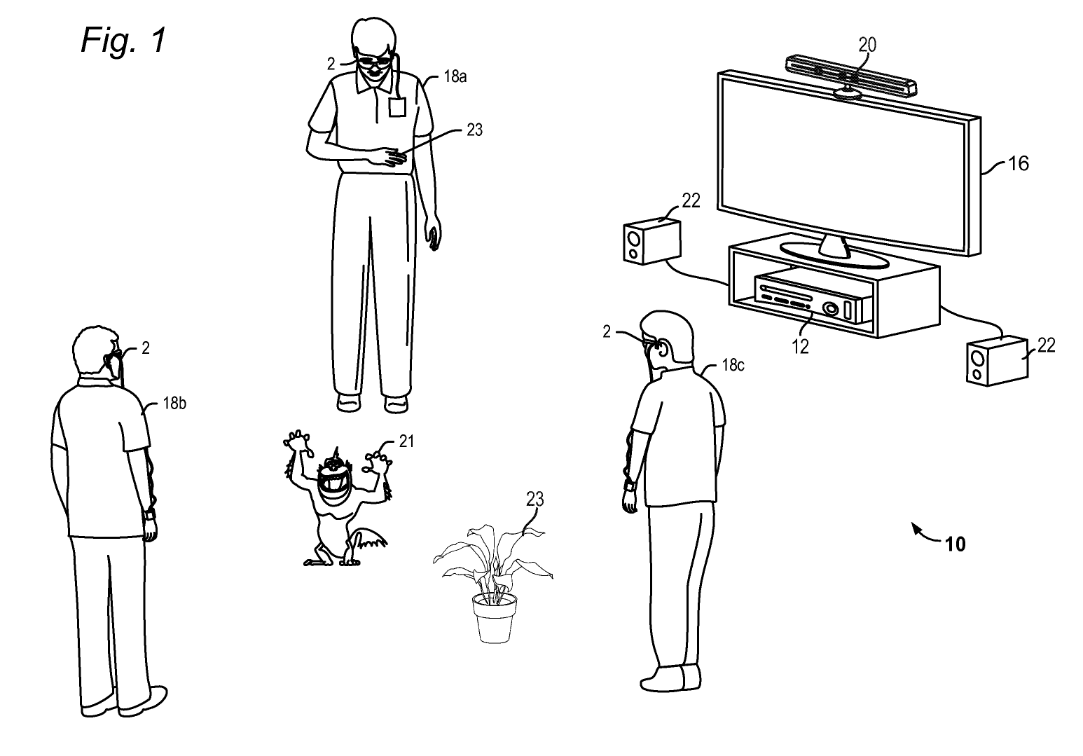

Embodiments of the present technology will now be described with reference to FIGS. 1-17, which in general relate to a mixed reality environment wherein the position and/or size of one or more virtual objects changes as a user moves within a physical environment so that the virtual objects remain accessible for interaction therewith. The system for implementing the mixed reality environment includes a mobile display device communicating with a hub computing system. The mobile display device may include a mobile processing unit coupled to a head mounted display device (or other suitable apparatus) having a display element.

Each user wears a head mounted display device including a display element. The display element is to a degree transparent so that a user can look through the display element at real world objects within the user's field of view (FOV). The display element also provides the ability to project virtual images into the FOV of the user such that the virtual images may also appear alongside the real world objects. The system automatically tracks where the user is looking so that the system can determine where to insert the virtual image in the FOV of the user. Once the system knows where to project the virtual image, the image is projected using the display element.

In embodiments, the hub computing system and one or more of the processing units may cooperate to build a model of the environment including the x, y, z Cartesian positions of all users, real world objects and virtual three-dimensional objects in the room or other environment. The positions of each head mounted display device worn by the users in the environment may be calibrated to the model of the environment and to each other. This allows the system to determine each user's line of sight and FOV of the environment. Thus, a virtual image may be displayed to each user, but the system determines the display of the virtual image from each user's perspective, adjusting the virtual image for parallax and any occlusions from or by other objects in the environment. The model of the environment, referred to herein as a scene map, as well as all tracking of the user's FOV and objects in the environment may be generated by the hub and computing device working in tandem or individually.

A user may choose to interact with one or more of the virtual objects appearing within the user's FOV. As used herein, the term “interact” encompasses both physical interaction and verbal interaction of a user with a virtual object. Physical interaction includes a user performing a predefined gesture using his or her fingers, hand, head and/or other body part(s) recognized by the mixed reality system as a user-request for the system to perform a predefined action. Such predefined gestures may include but are not limited to pointing at, grabbing, and pushing virtual objects.

A user may also physically interact with a virtual object with his or her eyes. In some instances, eye gaze data identifies where a user is focusing in the FOV, and can thus identify that a user is looking at a particular virtual object. Sustained eye gaze, or a blink or blink sequence, may thus be a physical interaction whereby a user selects one or more virtual objects. A user simply looking at a virtual object, such as viewing content on a virtual display slate, is a further example of physical interaction of a user with a virtual object.

A user may alternatively or additionally interact with virtual objects using verbal gestures, such as for example a spoken word or phrase recognized by the mixed reality system as a user request for the system to perform a predefined action. Verbal gestures may be used in conjunction with physical gestures to interact with one or more virtual objects in the mixed reality environment.

In accordance with the present technology, when it is determined that a user is interacting with one or more virtual objects, the positions of the virtual object(s) may be altered so as to move with the user in three-dimensional space, and remain in a fixed position within the user's FOV for ease of interaction. As used herein, the term “position” encompasses both translational position with respect to a three-axis coordinate system, and rotational orientation (pitch, roll and/or yaw) about the axes of the coordinate system.

Embodiments are described below which optimize the positions of virtual objects such as a virtual display slate presenting content to a user. The content may be any content which can be displayed on the virtual slate, including for example static content such as text and pictures or dynamic content such as video. However, it is understood that the present technology is not limited to the positioning of virtual display slates, and may reposition and/or resize any virtual objects with which a user may interact.

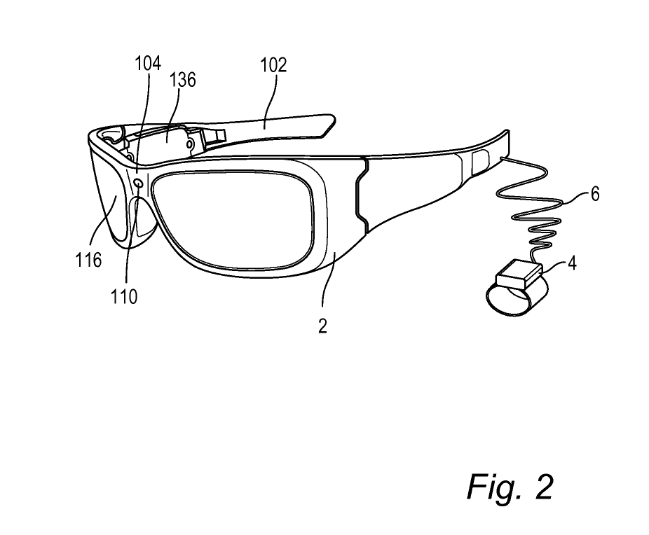

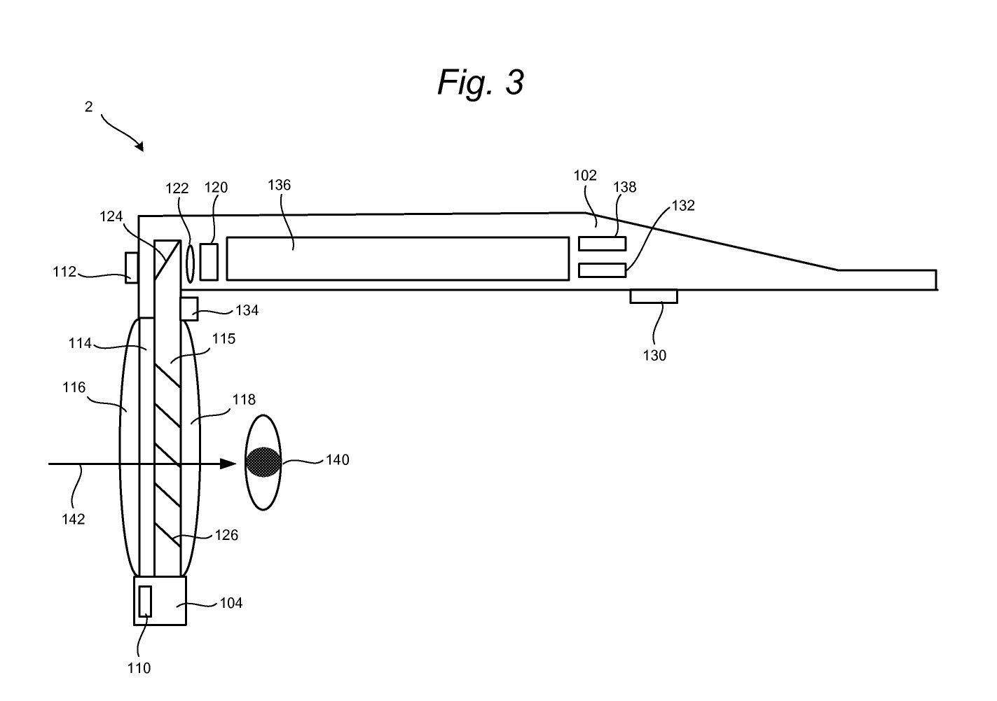

FIG. 1 illustrates a system 10 for providing a mixed reality experience by fusing virtual content 22 into real content 23 within a user's FOV. FIG. 1 shows a number of users 18a, 18b and 18c each wearing a head mounted display device 2. As seen in FIGS. 2 and 3, each head mounted display device 2 is in communication with its own processing unit 4 via wire 6. In other embodiments, head mounted display device 2 communicates with processing unit 4 via wireless communication. Head mounted display device 2, which in one embodiment is in the shape of glasses, is worn on the head of a user so that the user can see through a display and thereby have an actual direct view of the space in front of the user. The use of the term “actual direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

In one embodiment, processing unit 4 is a small, portable device for example worn on the user's wrist or stored within a user's pocket. The processing unit may for example be the size and form factor of a cellular telephone, though it may be other shapes and sizes in further examples. The processing unit 4 may include much of the computing power used to operate head mounted display device 2. In embodiments, the processing unit 4 communicates wirelessly (e.g., WiFi, Bluetooth, infra-red, or other wireless communication means) to one or more hub computing systems 12. As explained hereinafter, hub computing system 12 may be omitted in further embodiments to provide a completely mobile mixed reality experience using only the head mounted displays and processing units 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. In one embodiment, hub computing system 12 may include a processor such as a standardized processor, a specialized processor, a microprocessor, or the like that may execute instructions stored on a processor readable storage device for performing the processes described herein.

Hub computing system 12 further includes a capture device 20 for capturing image data from portions of a scene within its FOV. As used herein, a scene is the environment in which the users move around, which environment is captured within the FOV of the capture device 20 and/or the FOV of each head mounted display device 2. FIG. 1 shows a single capture device 20, but there may be multiple capture devices in further embodiments which cooperate to collectively capture image data from a scene within the composite FOVs of the multiple capture devices 20. Capture device 20 may include one or more cameras that visually monitor the one or more users 18a, 18b, 18c and the surrounding space such that gestures and/or movements performed by the one or more users, as well as the structure of the surrounding space, may be captured, analyzed, and tracked to perform one or more controls or actions within the application and/or animate an avatar or on-screen character.

Hub computing system 12 may be connected to an audiovisual device 16 such as a television, a monitor, a high-definition television (HDTV), or the like that may provide game or application visuals. For example, hub computing system 12 may include a video adapter such as a graphics card and/or an audio adapter such as a sound card that may provide audiovisual signals associated with the game application, non-game application, etc. The audiovisual device 16 may receive the audiovisual signals from hub computing system 12 and may then output the game or application visuals and/or audio associated with the audiovisual signals. According to one embodiment, the audiovisual device 16 may be connected to hub computing system 12 via, for example, an S-Video cable, a coaxial cable, an HDMI cable, a DVI cable, a VGA cable, a component video cable, RCA cables, etc. In one example, audiovisual device 16 includes internal speakers. In other embodiments, audiovisual device 16 and hub computing system 12 may be connected to external speakers 22.

Hub computing system 12, with capture device 20, may be used to recognize, analyze, and/or track human (and other types of) targets. For example, one or more of the users 18a, 18b and 18c wearing head mounted display devices 2 may be tracked using the capture device 20 such that the gestures and/or movements of the users may be captured to animate one or more avatars or on-screen characters. The movements may also or alternatively be interpreted as controls that may be used to affect the application being executed by hub computing system 12. The hub computing system 12, together with the head mounted display devices 2 and processing units 4, may also together provide a mixed reality experience where one or more virtual images, such as virtual image 21 in FIG. 1, may be mixed together with real world objects in a scene. FIG. 1 illustrates examples of a plant 23 or a user's hand 23 as real world objects appearing within the user's FOV.

FIGS. 2 and 3 show perspective and side views of the head mounted display device 2. FIG. 3 shows only the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). In one embodiment, see-through lenses 116 and 118 can be replaced by a variable prescription lens. In some embodiments, head mounted display device 2 will include only one see-through lens or no see-through lenses. In another alternative, a prescription lens can go inside light-guide optical element 115. Opacity filter 114 filters out natural light (either on a per pixel basis or uniformly) to enhance the contrast of the virtual imagery. Light-guide optical element 115 channels artificial light to the eye. More details of opacity filter 114 and light-guide optical element 115 are provided below.

Mounted to or inside temple 102 is an image source, which (in one embodiment) includes microdisplay 120 for projecting a virtual image and lens 122 for directing images from microdisplay 120 into light-guide optical element 115. In one embodiment, lens 122 is a collimating lens.

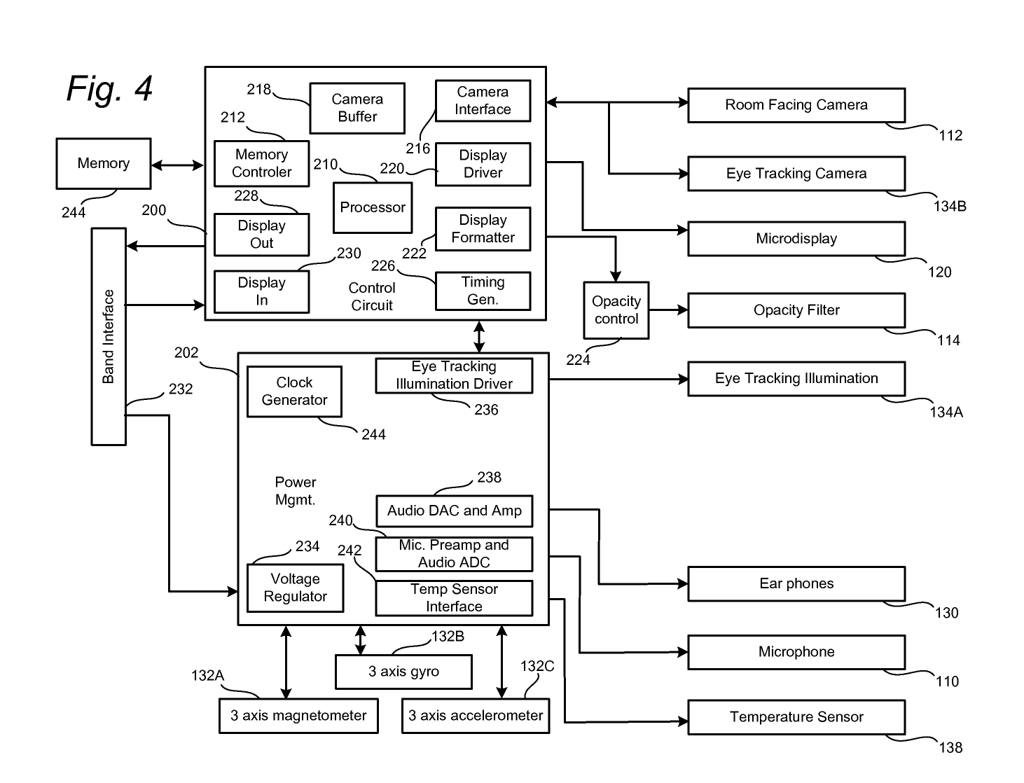

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that only one of the five surfaces is labeled 126 to prevent over-crowding of the drawing. Reflecting surfaces 126 couple the light waves incident upon those reflecting surfaces out of the substrate into the eye 140 of the user.

As different light rays will travel and bounce off the inside of the substrate at different angles, the different rays will hit the various reflecting surfaces 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light-guide optical element can be found in United States Patent Publication No. 2008/0285140, entitled “Substrate-Guided Optical Devices,” published on Nov. 20, 2008, incorporated herein by reference in its entirety. In one embodiment, each eye will have its own light-guide optical element 115. When the head mounted display device 2 has two light-guide optical elements, each eye can have its own microdisplay 120 that can display the same image in both eyes or different images in the two eyes. In another embodiment, there can be one light-guide optical element which reflects light into both eyes.

Opacity filter 114, which is aligned with light-guide optical element 115, selectively blocks natural light, either uniformly or on a per-pixel basis, from passing through light-guide optical element 115. Details of an opacity filter such as filter 114 are provided in U.S. Patent Publication No. 2012/0068913 to Bar-Zeev et al., entitled “Opacity Filter For See-Through Mounted Display,” filed on Sep. 21, 2010, incorporated herein by reference in its entirety. However, in general, an embodiment of the opacity filter 114 can be a see-through LCD panel, an electrochromic film, or similar device which is capable of serving as an opacity filter. Opacity filter 114 can include a dense grid of pixels, where the light transmissivity of each pixel is individually controllable between minimum and maximum transmissivities. While a transmissivity range of 0-100% is ideal, more limited ranges are also acceptable, such as for example about 50% to 90% per pixel, up to the resolution of the LCD.

A mask of alpha values can be used from a rendering pipeline, after z-buffering with proxies for real-world objects. When the system renders a scene for the augmented reality display, it takes note of which real-world objects are in front of which virtual objects as explained below. If a virtual object is in front of a real-world object, then the opacity may be on for the coverage area of the virtual object. If the virtual object is (virtually) behind a real-world object, then the opacity may be off, as well as any color for that pixel, so the user will only see the real-world object for that corresponding area (a pixel or more in size) of real light. Coverage would be on a pixel-by-pixel basis, so the system could handle the case of part of a virtual object being in front of a real-world object, part of the virtual object being behind the real-world object, and part of the virtual object being coincident with the real-world object. Displays capable of going from 0% to 100% opacity at low cost, power, and weight are the most desirable for this use. Moreover, the opacity filter can be rendered in color, such as with a color LCD or with other displays such as organic LEDs, to provide a wide FOV.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008, incorporated herein by reference. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but only one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 only shows half of the head mounted display device 2. A full head mounted display device would include another set of see-through lenses, another opacity filter, another light-guide optical element, another microdisplay 120, another lens 122, room-facing camera, eye tracking assembly, micro display, earphones, and temperature sensor.

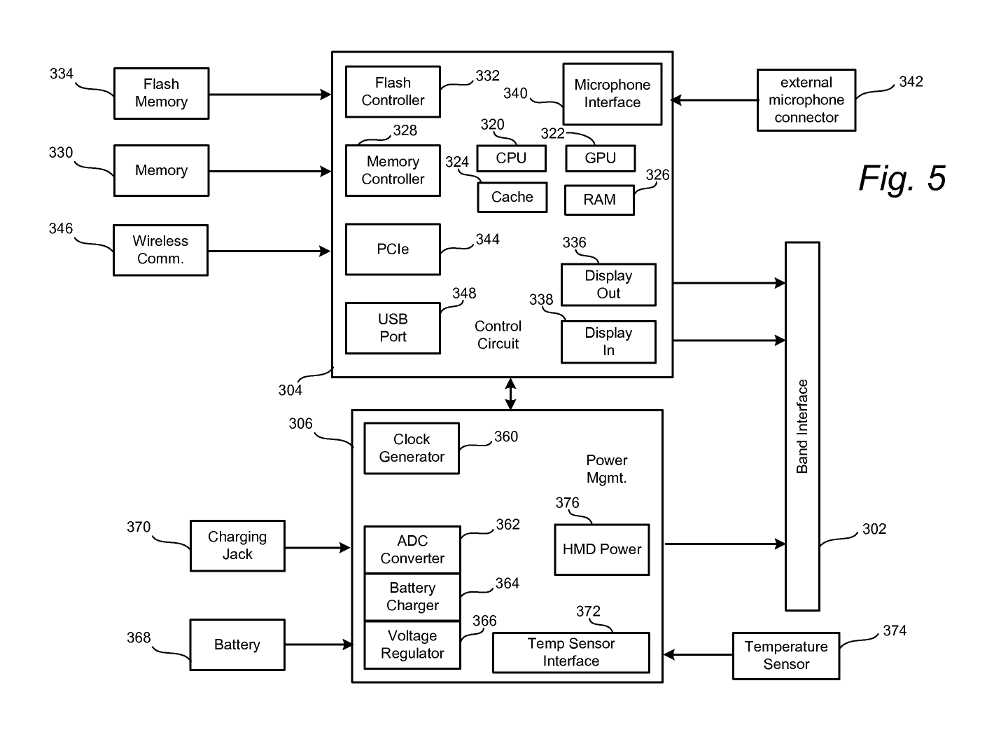

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2 and will exchange information and data with the hub computing system 12 (FIG. 1). Based on that exchange of information and data, processing unit 4 will determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, all of the components of control circuit 200 are in communication with each other via dedicated lines or one or more buses. In another embodiment, each of the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to hub computing system 12 in order to load data or software onto processing unit 4, as well as charge processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

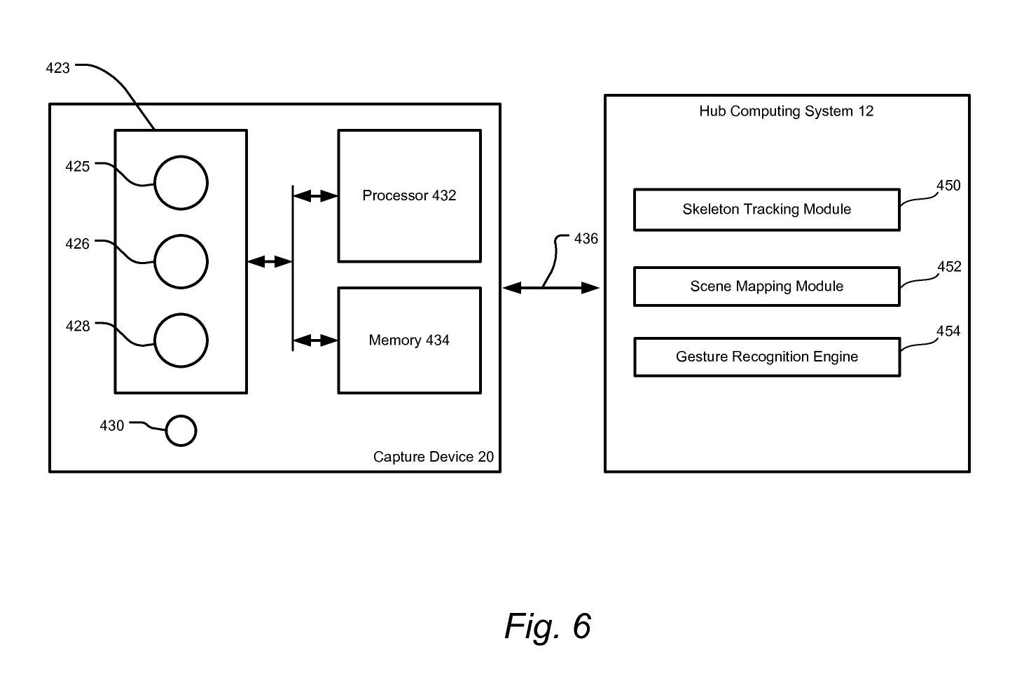

FIG. 6 illustrates an example embodiment of hub computing system 12 with a capture device 20. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 6, capture device 20 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 20 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, capture device 20 may use a structured light to capture depth information. In such an analysis, patterned light (i.e., light displayed as a known pattern such as a grid pattern, a stripe pattern, or different pattern) may be projected onto the scene via, for example, the IR light component 425. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR light component 425 is displaced from the cameras 426 and 428 so triangulation can be used to determined distance from cameras 426 and 428. In some implementations, the capture device 20 will include a dedicated IR sensor to sense the IR light, or a sensor with an IR filter.

According to another embodiment, one or more capture devices 20 may include two or more physically separated cameras that may view a scene from different angles to obtain visual stereo data that may be resolved to generate depth information. Other types of depth image sensors can also be used to create a depth image.

The capture device 20 may further include a microphone 430, which includes a transducer or sensor that may receive and convert sound into an electrical signal. Microphone 430 may be used to receive audio signals that may also be provided to hub computing system 12.

In an example embodiment, the capture device 20 may further include a processor 432 that may be in communication with the image camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 20 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 6, in one embodiment, memory 434 may be a separate component in communication with the image camera component 423 and processor 432. According to another embodiment, the memory 434 may be integrated into processor 432 and/or the image camera component 423.

Capture device 20 is in communication with hub computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, hub computing system 12 may provide a clock to capture device 20 that may be used to determine when to capture, for example, a scene via the communication link 436. Additionally, the capture device 20 provides the depth information and visual (e.g., RGB) images captured by, for example, the 3-D camera 426 and/or the RGB camera 428 to hub computing system 12 via the communication link 436. In one embodiment, the depth images and visual images are transmitted at 30 frames per second; however, other frame rates can be used. Hub computing system 12 may then create and use a model, depth information, and captured images to, for example, control an application such as a game or word processor and/or animate an avatar or on-screen character.

Hub computing system 12 includes a skeletal tracking module 450. Module 450 uses the depth images obtained in each frame from capture device 20, and possibly from cameras on the one or more head mounted display devices 2, to develop a representative model of each user 18a, 18b, 18c (or others) within the FOV of capture device 20 as each user moves around in the scene. This representative model may be a skeletal model described below. Hub computing system 12 may further include a scene mapping module 452. Scene mapping module 452 uses depth and possibly RGB image data obtained from capture device 20, and possibly from cameras on the one or more head mounted display devices 2, to develop a map or model of the scene in which the users 18a, 18b, 18c exist. The scene map may further include the positions of the users obtained from the skeletal tracking module 450. The hub computing system may further include a gesture recognition engine 454 for receiving skeletal model data for one or more users in the scene and determining whether the user is performing a predefined gesture or application-control movement affecting an application running on hub computing system 12.

The skeletal tracking module 450 and scene mapping module 452 are explained in greater detail below. More information about gesture recognition engine 454 can be found in U.S. patent application Ser. No. 12/422,661, entitled “Gesture Recognizer System Architecture,” filed on Apr. 13, 2009, incorporated herein by reference in its entirety. Additional information about recognizing gestures can also be found in U.S. patent application Ser. No. 12/391,150, entitled “Standard Gestures,” filed on Feb. 23, 2009; and U.S. patent application Ser. No. 12/474,655, entitled “Gesture Tool” filed on May 29, 2009, both of which are incorporated herein by reference in their entirety.

Capture device 20 provides RGB images (or visual images in other formats or color spaces) and depth images to hub computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as the distance of an object in the captured scene from the capture device. Hub computing system 12 will use the RGB images and depth images to develop a skeletal model of a user and to track a user's or other object's movements. There are many methods that can be used to model and track the skeleton of a person with depth images. One suitable example of tracking a skeleton using depth image is provided in U.S. patent application Ser. No. 12/603,437, entitled “Pose Tracking Pipeline” filed on Oct. 21, 2009, (hereinafter referred to as the '437 Application), incorporated herein by reference in its entirety.

The process of the '437 Application includes acquiring a depth image, down sampling the data, removing and/or smoothing high variance noisy data, identifying and removing the background, and assigning each of the foreground pixels to different parts of the body. Based on those steps, the system will fit a model to the data and create a skeleton. The skeleton will include a set of joints and connections between the joints. Other methods for user modeling and tracking can also be used. Suitable tracking technologies are also disclosed in the following four U.S. Patent Applications, all of which are incorporated herein by reference in their entirety: U.S. patent application Ser. No. 12/475,308, entitled “Device for Identifying and Tracking Multiple Humans Over Time,” filed on May 29, 2009; U.S. patent application Ser. No. 12/696,282, entitled “Visual Based Identity Tracking,” filed on Jan. 29, 2010; U.S. patent application Ser. No. 12/641,788, entitled “Motion Detection Using Depth Images,” filed on Dec. 18, 2009; and U.S. patent application Ser. No. 12/575,388, entitled “Human Tracking System,” filed on Oct. 7, 2009.

The above-described hub computing system 12, together with the head mounted display device 2 and processing unit 4, are able to insert a virtual three-dimensional object into the FOV of one or more users so that the virtual three-dimensional object augments and/or replaces the view of the real world. In one embodiment, head mounted display device 2, processing unit 4 and hub computing system 12 work together as each of the devices includes a subset of sensors that are used to obtain the data to determine where, when and how to insert the virtual three-dimensional object. In one embodiment, the calculations that determine where, when and how to insert a virtual three-dimensional object are performed by the hub computing system 12 and processing unit 4 working in tandem with each other. However, in further embodiments, all calculations may be performed by the hub computing system 12 working alone or the processing unit(s) 4 working alone. In other embodiments, at least some of the calculations can be performed by a head mounted display device 2.

In one example embodiment, hub computing system 12 and processing units 4 work together to create the scene map or model of the environment that the one or more users are in and track various moving objects in that environment. In addition, hub computing system 12 and/or processing unit 4 track the FOV of a head mounted display device 2 worn by a user 18a, 18b, 18c by tracking the position and orientation of the head mounted display device 2. Sensor information obtained by head mounted display device 2 is transmitted to processing unit 4. In one example, that information is transmitted to the hub computing system 12 which updates the scene model and transmits it back to the processing unit. The processing unit 4 then uses additional sensor information it receives from head mounted display device 2 to refine the FOV of the user and provide instructions to head mounted display device 2 on where, when and how to insert the virtual three-dimensional object. Based on sensor information from cameras in the capture device 20 and head mounted display device(s) 2, the scene model and the tracking information may be periodically updated between hub computing system 12 and processing unit 4 in a closed loop feedback system as explained below.

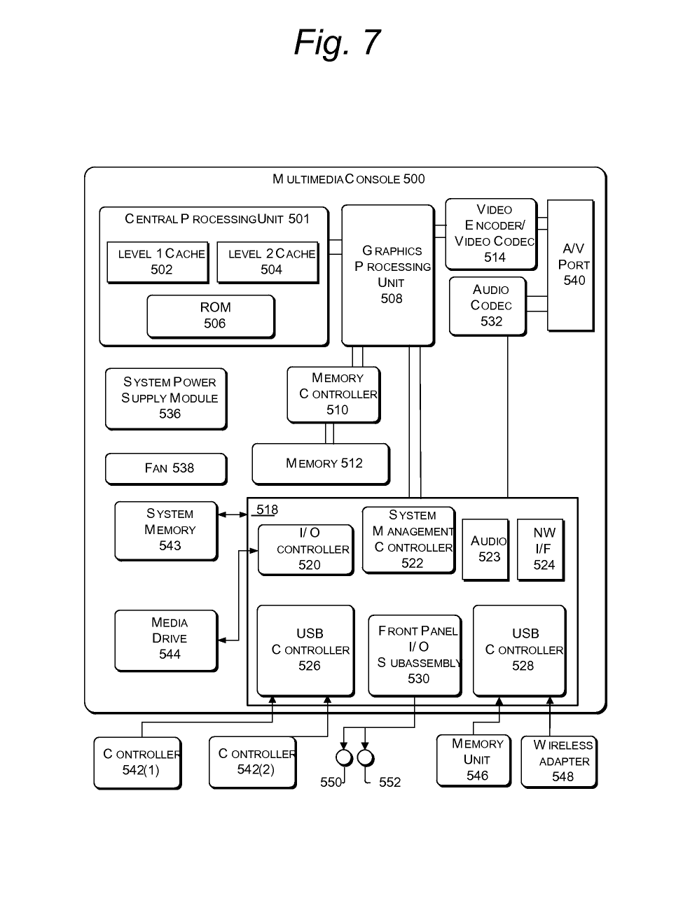

FIG. 7 illustrates an example embodiment of a computing system that may be used to implement hub computing system 12. As shown in FIG. 7, the multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 20 may define additional input devices for the console 500 via USB controller 526 or other interface. In other embodiments, hub computing system 12 can be implemented using other hardware architectures. No one hardware architecture is required.

Each of the head mounted display devices 2 and processing units 4 (collectively referred to at times as the mobile display device) shown in FIG. 1 are in communication with one hub computing system 12 (also referred to as the hub 12). There may be one or two or more mobile display devices in communication with the hub 12 in further embodiments. Each of the mobile display devices may communicate with the hub using wireless communication, as described above. In such an embodiment, it is contemplated that much of the information that is useful to the mobile display devices will be computed and stored at the hub and transmitted to each of the mobile display devices. For example, the hub will generate the model of the environment and provide that model to all of the mobile display devices in communication with the hub. Additionally, the hub can track the location and orientation of the mobile display devices and of the moving objects in the room, and then transfer that information to each of the mobile display devices.

In another embodiment, a system could include multiple hubs 12, with each hub including one or more mobile display devices. The hubs can communicate with each other directly or via the Internet (or other networks). Such an embodiment is disclosed in U.S. patent application Ser. No. 12/905,952 to Flaks et al., entitled “Fusing Virtual Content Into Real Content,” filed Oct. 15, 2010, which application is incorporated by reference herein in its entirety.

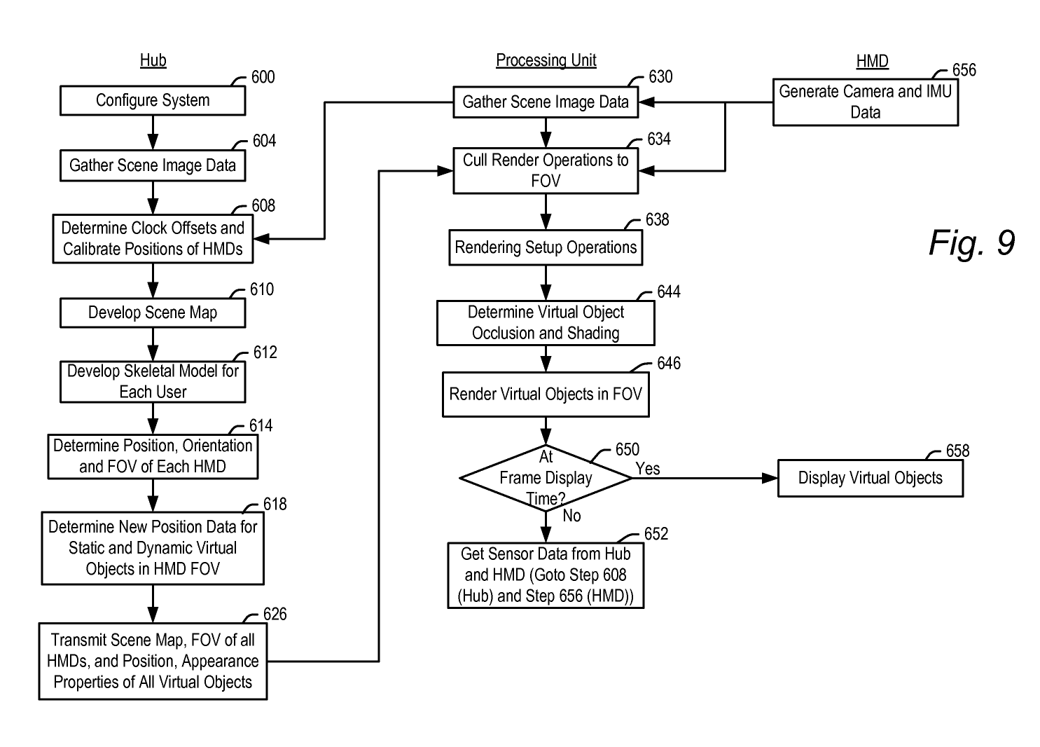

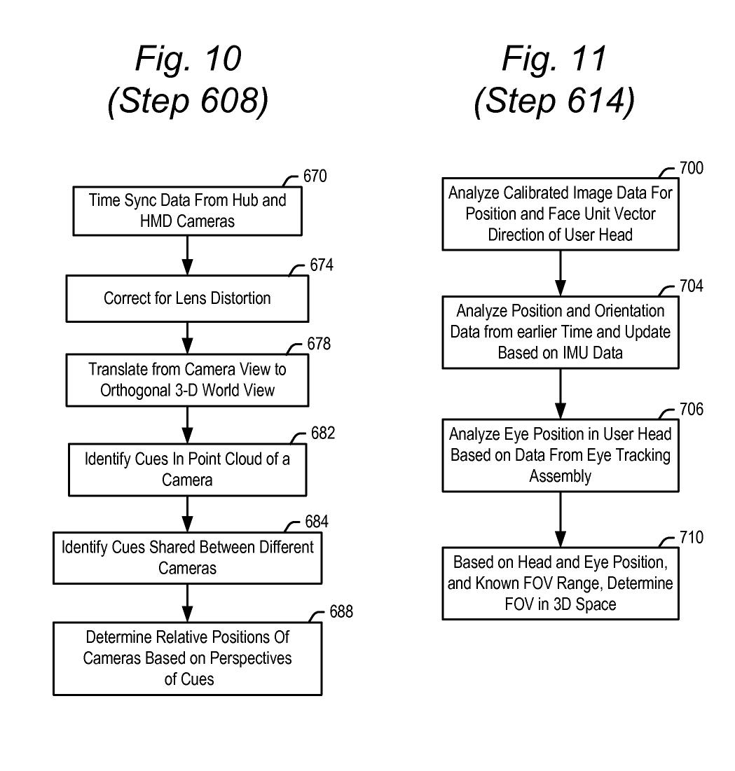

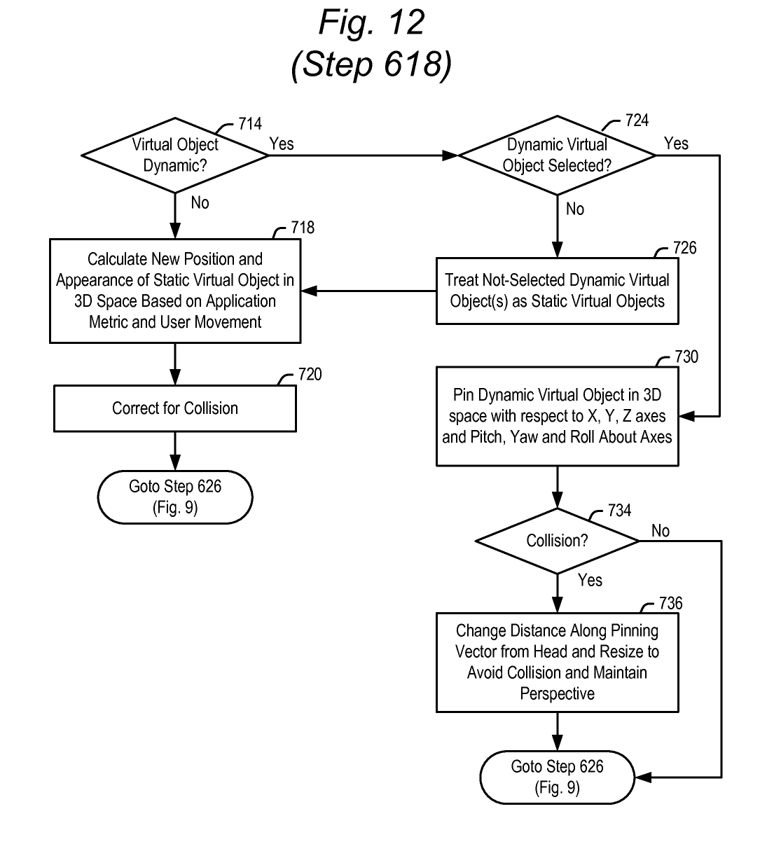

Moreover, in further embodiments, the hub 12 may be omitted altogether. One benefit of such an embodiment is that the mixed reality experience of the present system becomes completely mobile, and may be used in both indoor or outdoor settings. In such an embodiment, all functions performed by the hub 12 in the description that follows may alternatively be performed by one of the processing units 4, some of the processing units 4 working in tandem, or all of the processing units 4 working in tandem. In such an embodiment, the respective mobile display devices 580 perform all functions of system 10, including generating and updating state data, a scene map, each user's view of the scene map, all texture and rendering information, video and audio data, and other information to perform the operations described herein. The embodiments described below with respect to the flowchart of FIG. 9 include a hub 12. However, in each such embodiment, one or more of the processing units 4 may alternatively perform all described functions of the hub 12.

Using the components described above, virtual objects may be displayed to a user 18 via head mounted display device 2. Some virtual objects are intended to remain stationary within a scene. These virtual objects are referred to herein as “static virtual objects.” Other virtual objects are intended to move, or be movable, within a scene. These virtual objects are referred to as “dynamic virtual objects.”

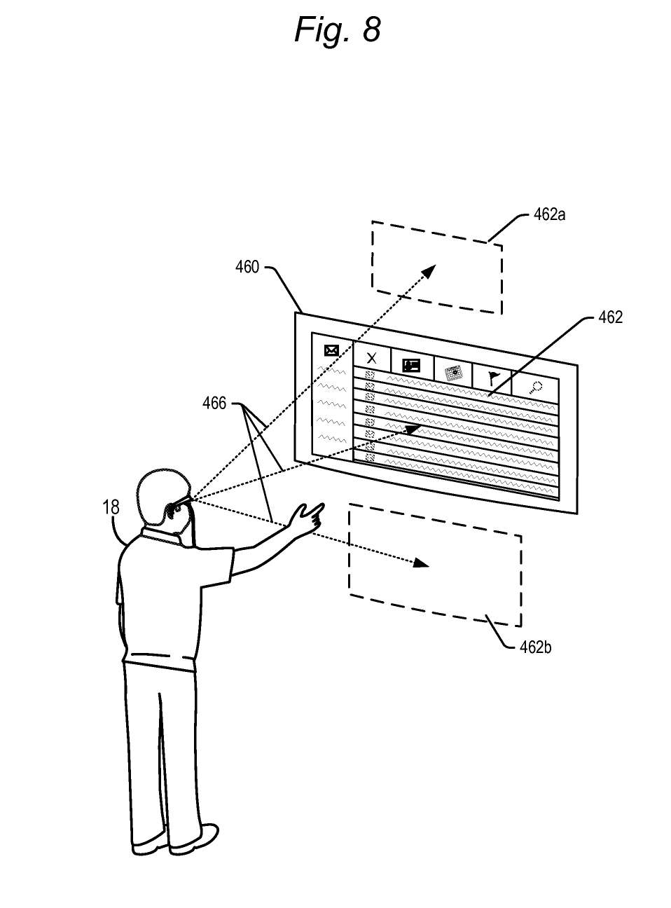

An example of a dynamic virtual object is the one or more virtual display slates 460 shown in FIG. 8. A virtual display slate 460 is a virtual screen displayed to the user on which content 462 is presented to the user. The opacity filter 114 is used to mask real world objects and light behind (from the user's view point) the virtual display slate 460, so that the virtual display slate 460 appears as a virtual screen for viewing selected content 462.

The content 462 may be a wide variety of content, including static content such as text and graphics, or dynamic content such as video. A slate 460 may further act as a computer monitor, so that the content 462 may be email, web pages, games or any other content presented on a monitor. In the example shown, content 462 is a user interface from an email software application. It is understood that this illustration is by way of example only, and the content 462 can be any of a variety of user interfaces, graphics and/or videos. A software application running on hub 12 may generate the slate 460, as well as determine the content 462 to be displayed on slate 460. In embodiments, the position and size of slate 460, as well as the type of content 462 displayed on slate 460, may be user configurable through gestures and the like.

It is also understood that more than one virtual display slate 460 may be presented to the user, such as slates 460a and 460b in addition to slate 460. Slates 460a, 460b may be positioned as desired by the user, and may present any content desired by the user. More than three virtual display slates 460 may be presented in further embodiments, arranged as desired by the user 18.

A user may select a given dynamic virtual object such as slate 460, and thereafter move, resize or hide the object. For example, a user may select slate 460 by performing a grabbing or pointing gesture with his hand (as shown in FIG. 8), or a user may stare at the slate 460. Thereafter, the user 18 may move the slate 460 within the user's FOV or outside of the user's FOV. Moreover, as explained below with reference to the flowchart of FIG. 9, the one or more virtual display slates 460 (or other virtual objects) may automatically move, rotate or resize as the user moves around within an environment to allow easy interaction with the one or more virtual display slates 460.

FIG. 9 is a high level flowchart of the operation and interactivity of the hub computing system 12, the processing unit 4 and head mounted display device 2 during a discrete time period such as the time it takes to generate, render and display a single frame of image data to each user. In embodiments, data may be refreshed at a rate of 60 Hz, though it may be refreshed more often or less often in further embodiments.

In general, the system generates a scene map having x, y, z coordinates of the environment and objects in the environment such as users, real world objects and virtual objects. As noted above, the virtual object such as slate 460 may be virtually placed in the environment for example by an application running on hub computing system 12. The system also tracks the FOV of each user. While all users may possibly be viewing the same aspects of the scene, they are viewing them from different perspectives. Thus, the system generates each person's FOV of the scene to adjust for parallax and occlusion of virtual or real world objects, which may again be different for each user.

For a given frame of image data, a user's view may include one or more real and/or virtual objects. As a user turns his head, for example left to right or up and down, the relative position of real world objects in the user's FOV inherently moves within the user's FOV. For example, plant 23 in FIG. 1 may appear on the right side of a user's FOV at first. But if the user then turns his head toward the right, the plant 23 may eventually end up on the left side of the user's FOV.

However, the display of virtual objects to a user as the user moves his head is a more difficult problem. In an example where a user is looking at a static virtual object in his FOV, if the user moves his head left to move the FOV left, the display of the static virtual object needs to be shifted to the right by an amount of the user's FOV shift, so that the net effect is that the static virtual object remains stationary within the FOV. However, in accordance with the present technology, some dynamic virtual objects move with the user as the user moves his head, sits down, walks or otherwise moves his body. A system for properly displaying static and dynamic virtual objects is explained below with respect to the flowchart of FIGS. 9-13.

The system for presenting mixed reality to one or more users 18 may be configured in step 600. For example, a user 18 or operator of the system may specify the virtual objects that are to be presented, whether they are to be static or dynamic virtual objects, and how, when and where they are to be presented. In an alternative embodiment, an application running on hub 12 and/or processing unit 4 can configure the system as to the static and/or dynamic virtual objects that are to be presented.

In one example, the application may select one or more static and/or dynamic virtual objects for presentation in default locations within the scene. Alternatively or additionally, the user may select one or more predefined static and/or dynamic virtual objects for inclusion in the scene. Whether selected by the application or user, the user may thereafter have the option to change the default position of one or more of the dynamic virtual objects. For example, the user may select a virtual display slate 460 for positioning at the center or near center of his FOV. Alternatively, a user may send a virtual display slate 460 onto a wall. These options may for example be carried out by the user performing grabbing and moving gestures with his hands, though it may be carried out in other ways in further embodiments.

In steps 604 and 630, hub 12 and processing unit 4 gather data from the scene. For the hub 12, this may be image and audio data sensed by the depth camera 426, RGB camera 428 and microphone 430 of capture device 20. For the processing unit 4, this may be image data sensed in step 656 by the head mounted display device 2, and in particular, by the cameras 112, the eye tracking assemblies 134 and the IMU 132. The data gathered by the head mounted display device 2 is sent to the processing unit 4 in step 656. The processing unit 4 processes this data, as well as sending it to the hub 12 in step 630.

In step 608, the hub 12 performs various setup operations that allow the hub 12 to coordinate the image data of its capture device 20 and the one or more processing units 4. In particular, even if the position of the capture device 20 is known with respect to a scene (which it may not be), the cameras on the head mounted display devices 2 are moving around in the scene. Therefore, in embodiments, the positions and time capture of each of the imaging cameras need to be calibrated to the scene, each other and the hub 12. Further details of step 608 are now described with reference to the flowchart of FIG. 10.

One operation of step 608 includes determining clock offsets of the various imaging devices in the system 10 in a step 670. In particular, in order to coordinate the image data from each of the cameras in the system, it may be confirmed that the image data being coordinated is from the same time. Details relating to determining clock offsets and synching of image data are disclosed in U.S. patent application Ser. No. 12/772,802, entitled “Heterogeneous Image Sensor Synchronization,” filed May 3, 2010, and U.S. patent application Ser. No. 12/792,961, entitled “Synthesis Of Information From Multiple Audiovisual Sources,” filed Jun. 3, 2010, which applications are incorporated herein by reference in their entirety. In general, the image data from capture device 20 and the image data coming in from the one or more processing units 4 are time stamped off a single master clock in hub 12. Using the time stamps for all such data for a given frame, as well as the known resolution for each of the cameras, the hub 12 determines the time offsets for each of the imaging cameras in the system. From this, the hub 12 may determine the differences between, and an adjustment to, the images received from each camera.

The hub 12 may select a reference time stamp from one of the cameras' received frame. The hub 12 may then add time to or subtract time from the received image data from all other cameras to synch to the reference time stamp. It is appreciated that a variety of other operations may be used for determining time offsets and/or synchronizing the different cameras together for the calibration process. The determination of time offsets may be performed once, upon initial receipt of image data from all the cameras. Alternatively, it may be performed periodically, such as for example each frame or some number of frames.

Step 608 further includes the operation of calibrating the positions of all cameras with respect to each other in the x, y, z Cartesian space of the scene. Once this information is known, the hub 12 and/or the one or more processing units 4 is able to form a scene map or model identify the geometry of the scene and the geometry and positions of objects (including users) within the scene. In calibrating the image data of all cameras to each other, depth and/or RGB data may be used. Technology for calibrating camera views using RGB information alone is described for example in U.S. Patent Publication No. 2007/0110338, entitled “Navigating Images Using Image Based Geometric Alignment and Object Based Controls,” published May 17, 2007, which publication is incorporated herein by reference in its entirety.

The imaging cameras in system 10 may each have some lens distortion which needs to be corrected for in order to calibrate the images from different cameras. Once all image data from the various cameras in the system is received in steps 604 and 630, the image data may be adjusted to account for lens distortion for the various cameras in step 674. The distortion of a given camera (depth or RGB) may be a known property provided by the camera manufacturer. If not, algorithms are known for calculating a camera's distortion, including for example imaging an object of known dimensions such as a checker board pattern at different locations within a camera's FOV. The deviations in the camera view coordinates of points in that image will be the result of camera lens distortion. Once the degree of lens distortion is known, distortion may be corrected by known inverse matrix transformations that result in a uniform camera view map of points in a point cloud for a given camera.

The hub 12 may next translate the distortion-corrected image data points captured by each camera from the camera view to an orthogonal 3-D world view in step 678. This orthogonal 3-D world view is a point cloud map of all image data captured by capture device 20 and the head mounted display device cameras in an orthogonal x, y, z Cartesian coordinate system. The matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000), which publication is incorporated herein by reference in its entirety. See also, U.S. patent application Ser. No. 12/792,961, previously incorporated by reference.

Each camera in system 10 may construct an orthogonal 3-D world view in step 678. The x, y, z world coordinates of data points from a given camera are still from the perspective of that camera at the conclusion of step 678, and not yet correlated to the x, y, z world coordinates of data points from other cameras in the system 10. The next step is to translate the various orthogonal 3-D world views of the different cameras into a single overall 3-D world view shared by all cameras in system 10.

To accomplish this, embodiments of the hub 12 may next look for key-point discontinuities, or cues, in the point clouds of the world views of the respective cameras in step 682, and then identifies cues that are the same between different point clouds of different cameras in step 684. Once the hub 12 is able to determine that two world views of two different cameras include the same cues, the hub 12 is able to determine the position, orientation and focal length of the two cameras with respect to each other and the cues in step 688. In embodiments, not all cameras in system 10 will share the same common cues. However, as long as a first and second camera have shared cues, and at least one of those cameras has a shared view with a third camera, the hub 12 is able to determine the positions, orientations and focal lengths of the first, second and third cameras relative to each other and a single, overall 3-D world view. The same is true for additional cameras in the system.

Various known algorithms exist for identifying cues from an image point cloud. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630. (2005), which paper is incorporated by reference herein in its entirety. A further method of detecting cues with image data is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image,” issued Mar. 23, 2004, which patent is incorporated by reference herein in its entirety. Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002), which paper is incorporated by reference herein in its entirety.

In step 684, cues which are shared between point clouds from two or more cameras are identified. Conceptually, where a first set of vectors exist between a first camera and a set of cues in the first camera's Cartesian coordinate system, and a second set of vectors exist between a second camera and that same set of cues in the second camera's Cartesian coordinate system, the two systems may be resolved with respect to each other into a single Cartesian coordinate system including both cameras. A number of known techniques exist for finding shared cues between point clouds from two or more cameras. Such techniques are shown for example in Arya, S., Mount, D. M., Netanyahu, N. S., Silverman, R., and Wu, A. Y., “An Optimal Algorithm For Approximate Nearest Neighbor Searching Fixed Dimensions,” Journal of the ACM 45, 6, 891-923 (1998), which paper is incorporated by reference herein in its entirety. Other techniques can be used instead of, or in addition to, the approximate nearest neighbor solution of Arya et al., incorporated above, including but not limited to hashing or context-sensitive hashing.

Where the point clouds from two different cameras share a large enough number of matched cues, a matrix correlating the two point clouds together may be estimated, for example by Random Sampling Consensus (RANSAC), or a variety of other estimation techniques. Matches that are outliers to the recovered fundamental matrix may then be removed. After finding a set of assumed, geometrically consistent matches between a pair of point clouds, the matches may be organized into a set of tracks for the respective point clouds, where a track is a set of mutually matching cues between point clouds. A first track in the set may contain a projection of each common cue in the first point cloud. A second track in the set may contain a projection of each common cue in the second point cloud. The point clouds from different cameras may then be resolved into a single point cloud in a single orthogonal 3-D real world view.

The positions and orientations of all cameras are calibrated with respect to this single point cloud and single orthogonal 3-D real world view. In order to resolve the various point clouds together, the projections of the cues in the set of tracks for two point clouds are analyzed. From these projections, the hub 12 can determine the perspective of a first camera with respect to the cues, and can also determine the perspective of a second camera with respect to the cues. From that, the hub 12 can resolve the point clouds into an estimate of a single point cloud and single orthogonal 3-D real world view containing the cues and other data points from both point clouds.

This process is repeated for any other cameras, until the single orthogonal 3-D real world view includes all cameras. Once this is done, the hub 12 can determine the relative positions and orientations of the cameras relative to the single orthogonal 3-D real world view and each other. The hub 12 can further determine the focal length of each camera with respect to the single orthogonal 3-D real world view.

Referring again to FIG. 9, once the system is calibrated in step 608, a scene map may be developed in step 610 identifying the geometry of the scene as well as the geometry and positions of objects within the scene. In embodiments, the scene map generated in a given frame may include the x, y and z positions of all users, real world objects and virtual objects in the scene. All of this information is obtained during the image data gathering steps 604, 630 and 656 and is calibrated together in step 608.

At least the capture device 20 includes a depth camera for determining the depth of the scene (to the extent it may be bounded by walls, etc.) as well as the depth position of objects within the scene. As explained below, the scene map is used in positioning virtual objects within the scene, as well as displaying virtual three-dimensional objects with the proper occlusion (a virtual three-dimensional object may be occluded, or a virtual three-dimensional object may occlude, a real world object or another virtual three-dimensional object).

The system 10 may include multiple depth image cameras to obtain all of the depth images from a scene, or a single depth image camera, such as for example depth image camera 426 of capture device 20 may be sufficient to capture all depth images from a scene. An analogous method for determining a scene map within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping,” issued Aug. 10, 2010, which patent is incorporated herein by reference in its entirety.

In step 612, the system will detect and track moving objects such as humans moving in the room, and update the scene map based on the positions of moving objects. This includes the use of skeletal models of the users within the scene as described above. In step 614, the hub determines the x, y and z position, the orientation and the FOV of each head mounted display device 2 for all users within the system 10. Further details of step 614 are now described with respect to the flowchart of FIG. 11. The steps of FIG. 11 are described below with respect to a single user. However, the steps of FIG. 11 would be carried out for each user within the scene.

In step 700, the calibrated image data for the scene is analyzed at the hub to determine both the user head position and a face unit vector looking straight out from a user's face. The head position is identified in the skeletal model. The face unit vector may be determined by defining a plane of the user's face from the skeletal model, and taking a vector perpendicular to that plane. This plane may be identified by determining a position of a user's eyes, nose, mouth, ears or other facial features. The face unit vector may be used to define the user's head orientation and, in examples, may be considered the center of the FOV for the user. The face unit vector may also or alternatively be identified from the camera image data returned from the cameras 112 on head mounted display device 2. In particular, based on what the cameras 112 on head mounted display device 2 see, the associated processing unit 4 and/or hub 12 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from capture device 20, the cameras on the head mounted display device 2 for the subject user and/or from the head mounted display device(s) 2 of other users.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the hub may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined. The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what a user cannot see. As explained below, limiting processing of virtual objects to only those areas that a particular user can see improves processing speed and reduces latency.

In the embodiment described above, the hub 12 calculates the FOV of the one or more users in the scene. In further embodiments, the processing unit 4 for a user may share in this task. For example, once user head position and eye orientation are estimated, this information may be sent to the processing unit which can update the position, orientation, etc. based on more recent data as to head position (from IMU 132) and eye position (from eye tracking assembly 134).

Returning now to FIG. 9, an application running on hub 12 may have placed static and/or dynamic virtual objects in the scene. In step 618, the hub may use the scene map and any application-defined movement of the static virtual objects, to determine the x, y and z positions of all such static and dynamic virtual objects at the current time. Alternatively, this information may be generated by one or more of the processing units 4 and sent to the hub 12 in step 618.

Further details of step 618 are now described with reference to the flowchart of FIG. 12. In step 714, the hub determines whether the virtual three-dimensional object is a dynamic or static virtual object. If it is determined the virtual object is not dynamic (and is thus static), the hub 12 calculates a new position of the static virtual three-dimensional object in step 718 based on one or more application metrics. For example, the application may set whether and how fast the virtual three-dimensional object is moving in a scene. It may determine a change in shape, appearance or orientation of the virtual three-dimensional object. The application may affect a variety of other changes to a virtual object.

Moreover, a user moving within a scene may change the appearance of a static virtual object. For example, if a user moves closer to a static virtual object, the object may be projected larger. If a user moves around a static virtual object, the virtual object is displayed from a different vantage point. This information may be determined from steps 700, 704, 706 and 710 described above for FIG. 11, where the user's FOV is determined relative to the scene map.

These changes in the displayed appearance of the static virtual object are provided to the hub 12 in step 718, and the hub can then update the position, orientation, shape, appearance, etc. of the virtual three-dimensional object in step 718. In step 720, the hub may check whether the updated virtual object occupies the same space as a real world object in the scene. In particular, positions of real world objects may be identified in three dimensional space, and positions of the updated virtual object may also be known in three dimensional space. If there is any overlap, the hub 12 may adjust the position of the virtual object according to default rules or metrics defined in the application.

In accordance with the present technology, if it is determined in step 714 that the virtual three-dimensional object is a dynamic virtual object, the position of the virtual object may be pinned to a constant position in the user's FOV. As noted above, a user may move around within a scene by walking, sitting, bending, turning his head, moving his eyes, or other body movement that results in a change in the user's FOV. It may be that, despite these changes in the user's FOV, the user wants to maintain easy access to selected virtual objects with which the user is interacting. Therefore, the present technology enables these selected dynamic virtual objects to move around with the user as the user's FOV changes so that the selected dynamic virtual objects is displayed in a constant position relative to the user's FOV, where it remains easily accessible for interaction.

In step 724, the hub 12 determines which, if any, dynamic virtual objects are selected by the user. Selection of one or more dynamic virtual objects may be indicated by any of several gestures, such as for example the user having pointed at one or more dynamic virtual objects in the current or previous frames. Alternatively or additionally, the hub 12 may determine that the user's gaze is fixed on one or more virtual objects in the current or previous frames. Once selected, the one or more dynamic virtual objects may remain selected, until the user performs another gesture indicating de-selection of one or more dynamic virtual objects. A de-selection gesture may for example be a physical hand gesture or the user looking away from the one or more dynamic virtual objects for a predetermined period of time.

If it is determined in step 724 that a given dynamic virtual object is not selected, that non-selected dynamic object may be treated as a static object in the current frame for the purposes of its display in step 726. The non-selected dynamic virtual object may thus remain stationary relative to the scene map, and the flow goes to step 718 for calculation of the new position and appearance of the non-selected dynamic virtual object(s).

On the other hand, if it is determined in step 724 that a dynamic virtual object is selected, the dynamic virtual object is pinned to a constant position relative to the user's FOV in step 730. As the user moves and the FOV changes, maintaining the dynamic virtual object in a constant position in the user's FOV results in the object moving the three dimensional space of the scene map. This movement can be translation along the x, y and/or z axes, and a rotation (pitch, yaw and/or roll) about the axes. This position is calculated in step 730.

One or more pinning vectors 466 (FIG. 8) may be defined out from a user's eyes which define the pinned position of the one or more dynamic virtual objects in the user's FOV. In an example where the dynamic virtual object is a slate 462, a given slate 462 may be positioned orthogonally to its pinning vector, at a desired distance away from the user. This pinned position within the user's FOV may be user-defined. The user may set a default location in the FOV for one or more dynamic virtual objects. The user may position a dynamic virtual object in the center of his view. Alternatively, the user may select a position left, right, up, down of the center of the FOV. Where a user has multiple dynamic virtual objects, the user may for example place one at the center of his view, and the others above and below (as in FIG. 8), or to the sides. The user may select a wide variety of other locations for dynamic virtual objects within his FOV.

The user may also grab and move one or more dynamic virtual objects from their default positions to new positions in the FOV. These new positions may be set as the new default positions, or the positions may revert back to the former default positions after the user de-selects, and then again selects, the dynamic virtual object.

As the positions of displayed virtual objects are updated several times a second, pinning a dynamic virtual object within the FOV may result in jerky movements of the dynamic virtual object as the user's eyes move around a scene. In embodiments, various measures may be taken to avoid this jerky motion. For example, a known smoothing algorithm may be used which blends the current determination of the pinning vector(s) with past positions of the pinning vector while ignoring noise or anomalous points of data. This results in a smooth movement of the pinning vector as a user moves his eyes.

Thus, there may be instances where a selected dynamic virtual object is not at a constant position within the user's FOV. For example, upon a sudden eye movement that changes the FOV for a short period of time, the FOV may change, but the virtual object does not move to the same extent (or not at all). However, in embodiments, the hub 12 displays the virtual image to the user at positions in three-dimensional space that, over some predetermined period of time, average to a constant position within the user's field of view as the user moves. That predetermined period of time may be two or more frames of data. In further embodiments, the dynamic virtual object need not be at a constant position in the user's FOV over time, but may be displayed at different locations within a defined area of the FOV.

Additionally, movement of the pinning vector may be based off of movements of a user's head, and not their eyes. A combination of a smoothing algorithm and basing the pinning vector off of the user's head may be used in further embodiments. These measures may be omitted altogether in embodiments, so that the dynamic virtual objects move each frame with a user's eyes.

Using the above steps, selected dynamic virtual objects will move in three-dimensional space so as to remain in a fixed position and easily accessible in the user's FOV. It may happen when a dynamic virtual object is moved in this manner, it may occlude, or be occluded by, another virtual or real world object. This is handled by the processing unit 4 as explained below.

It may also happen that, upon repositioning in three-dimensional space, the dynamic virtual object collides with another object (real or virtual). This is checked in step 734. If a collision is detected, the dynamic virtual object may be moved closer to the user, or further away, along the pinning vector for that object in step 736 to avoid the collision. Such movement may be accompanied by a resizing of the object. Thus, if moved closer to the user, the dynamic virtual object may be made smaller, so that the overall perspective of the object remains the same to the user. If moved farther way, the object may be made larger, again so that the overall perspective of the object remains the same to the user.

Even where not colliding with another object, the user may move an object closer to or further away from the user. In embodiments, such movement may automatically result in a resizing of the dynamic virtual object, so that the perspective of the object to the user remains the same as described above. Thus for example, where a user moves a dynamic virtual object to a distant wall, the dynamic virtual object may automatically resize to be larger. In further embodiments, resizing of the dynamic virtual object may be manually performed, instead of automatically, upon moving of the dynamic virtual object to be closer or farther away.

Once the positions of both static and dynamic virtual objects are set as described in FIG. 12, the hub 12 may transmit the determined information to the one or more processing units 4 in step 626 (FIG. 9). The information transmitted in step 626 includes transmission of the scene map to the processing units 4 of all users. The transmitted information may further include transmission of the determined FOV of each head mounted display device 2 to the processing units 4 of the respective head mounted display devices 2. The transmitted information may further include transmission of static and dynamic virtual object characteristics, including the determined position, orientation, shape and appearance.

The processing steps 600 through 626 are described above by way of example only. It is understood that one or more of these steps may be omitted in further embodiments, the steps may be performed in differing order, or additional steps may be added. The processing steps 604 through 618 may be computationally expensive but the powerful hub 12 may perform these steps several times in a 60 Hertz frame. In further embodiments, one or more of the steps 604 through 618 may alternatively or additionally be performed by one or more of the one or more processing units 4. Moreover, while FIG. 9 shows determination of various parameters, and then transmission of these parameters all at once in step 626, it is understood that determined parameters may be sent to the processing unit(s) 4 asynchronously as soon as they are determined

The operation of the processing unit 4 and head mounted display device 2 will now be explained with reference to steps 630 through 656. The following description is of a single processing unit 4 and head mounted display device 2. However, the following description may apply to each processing unit 4 and display device 2 in the system.

As noted above, in an initial step 656, the head mounted display device 2 generates image and IMU data, which is sent to the hub 12 via the processing unit 4 in step 630. While the hub 12 is processing the image data, the processing unit 4 is also processing the image data, as well as performing steps in preparation for rendering an image.

In step 634, the processing unit 4 may cull the rendering operations so that only those virtual objects which could possibly appear within the final FOV of the head mounted display device 2 are rendered. The positions of other virtual objects may still be tracked, but they are not rendered. It is also conceivable that, in further embodiments, step 634 may be skipped altogether and the entire image is rendered.

The processing unit 4 may next perform a rendering setup step 638 where setup rendering operations are performed using the scene map and FOV received in step 626. Once virtual object data is received, the processing unit may perform rendering setup operations in step 638 for the virtual objects which are to be rendered in the FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

Referring again to FIG. 9, using the information received from the hub 12 in step 626, the processing unit 4 may next determine occlusions and shading in the user's FOV in step 644. In particular, the screen map has x, y and z positions of all objects in the scene, including moving and non-moving objects and the virtual objects. Knowing the location of a user and their line of sight to objects in the FOV, the processing unit 4 may then determine whether a virtual object partially or fully occludes the user's view of a real world object. Additionally, the processing unit 4 may determine whether a real world object partially or fully occludes the user's view of a virtual object. Occlusions are user-specific. A virtual object may block or be blocked in the view of a first user, but not a second user. Accordingly, occlusion determinations may be performed in the processing unit 4 of each user. However, it is understood that occlusion determinations may additionally or alternatively be performed by the hub 12.

In the context of the present technology, the processing unit 4 checks in step 644 whether a repositioned dynamic virtual object such as a slate 460 occludes or is occluded by another object. As noted above and explained below, the opacity filter 114 allows slate 460 to be displayed while blocking light from virtual and real world object that appear behind the slate 460 (from the user's point of view). The slate 460 may be occluded by object appearing closer to the user that slate 460. In that case, the user may do nothing (and leave the slate 460 occluded), or the user may reposition the slate 460 in front of the occluding object. In this instance, the slate 460 may be made smaller to maintain the same perspective of the slate 460 to the user.

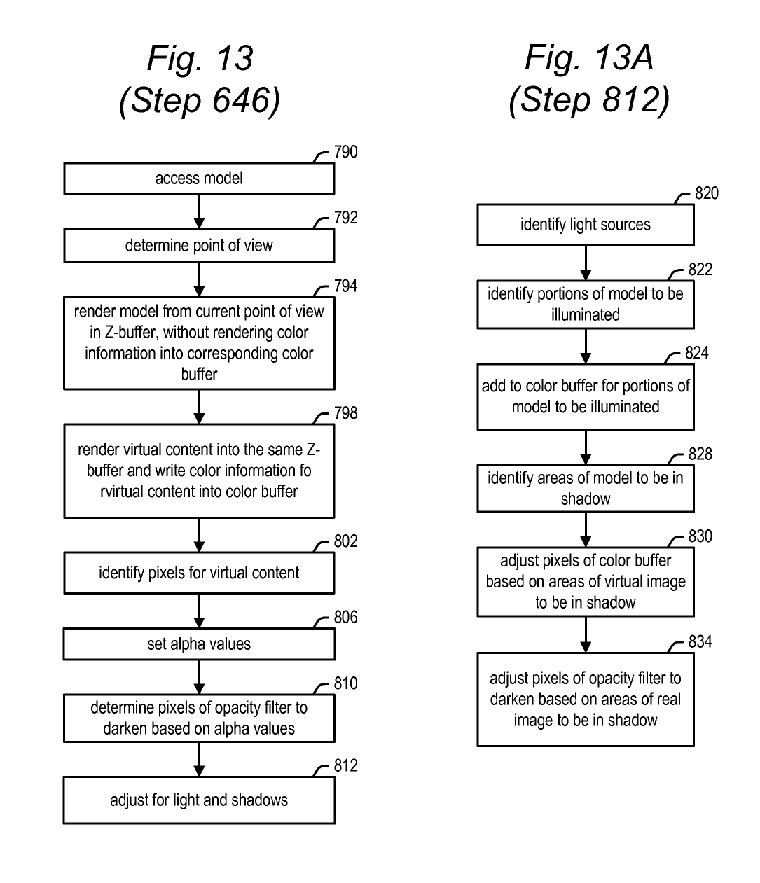

In step 646, the GPU 322 of processing unit 4 may next render an image to be displayed to the user. Portions of the rendering operations may have already been performed in the rendering setup step 638 and periodically updated. Further details of the rendering step 646 are now described with reference to the flowchart of FIGS. 13 and 13A. FIGS. 13 and 13A are described with respect to an example of rendering a virtual display slate 460, though the following steps apply to rending all virtual objects, both static and dynamic.

In step 790 of FIG. 13, the processing unit 4 accesses the model of the environment. In step 792, the processing unit 4 determines the point of view of the user with respect to the model of the environment. That is, the system determines what portion of the environment or space the user is looking at. In one embodiment, step 792 is a collaborative effort using hub computing device 12, processing unit 4 and head mounted display device 2 as described above.

In one embodiment, the processing unit 4 will attempt to add one or more virtual display slates 460 into a scene. In step 794, the system renders the previously created three dimensional model of the environment from the point of view of the user of head mounted display device 2 in a z-buffer, without rendering any color information into the corresponding color buffer. This effectively leaves the rendered image of the environment to be all black, but does store the z (depth) data for the objects in the environment. Step 794 results in a depth value being stored for each pixel (or for a subset of pixels).

In step 798, virtual content (e.g., virtual images corresponding to the virtual display slates 460) is rendered into the same z-buffer and the color information for the virtual content is written into the corresponding color buffer. This effectively allows the virtual display slates 460 to be drawn on the headset microdisplay 120 taking into account real world objects or other virtual objects occluding all or part of a virtual display slate.

In step 802, the system identifies the pixels of microdisplay 120 that display virtual display slates. In step 806, alpha values are determined for the pixels of microdisplay 120. In traditional chroma key systems, the alpha value is used to identify how opaque an image is, on a pixel-by-pixel basis. In some applications, the alpha value can be binary (e.g., on or off). In other applications, the alpha value can be a number with a range. In one example, each pixel identified in step 802 will have a first alpha value and all other pixels will have a second alpha value.

In step 810, the pixels for the opacity filter 114 are determined based on the alpha values. In one example, the opacity filter 114 has the same resolution as microdisplay 120 and, therefore, the opacity filter can be controlled using the alpha values. In another embodiment, the opacity filter has a different resolution than microdisplay 120 and, therefore, the data used to darken or not darken the opacity filter will be derived from the alpha value by using any of various mathematical algorithms for converting between resolutions. Other means for deriving the control data for the opacity filter based on the alpha values (or other data) can also be used.

In step 812, the images in the z-buffer and color buffer, as well as the alpha values and the control data for the opacity filter, are adjusted to account for light sources (virtual or real) and shadows (virtual or real). More details of step 812 are provided below with respect to FIG. 13A. The process of FIG. 13 allows for automatically displaying a virtual display slate 460 over a stationary or moving object (or in relation to a stationary or moving object) on a display that allows actual direct viewing of at least a portion of the space through the display.

FIG. 13A is a flowchart describing one embodiment of a process for accounting for light sources and shadows, which is an example implementation of step 812 of FIG. 13. In step 820, processing unit 4 identifies one or more light sources that need to be accounted for. For example, a real light source may need to be accounted for when drawing a virtual image. If the system is adding a virtual light source to the user's view, then the effect of that virtual light source can be accounted for in the head mounted display device 2 as well. In step 822, the portions of the model (including virtual objects) that are illuminated by the light source are identified. In step 824, an image depicting the illumination is added to the color buffer described above.

In step 828, processing unit 4 identifies one or more areas of shadow that need to be added by the head mounted display device 2. For example, if a virtual object is added to an area in a shadow, then the shadow needs to be accounted for when drawing the virtual object by adjusting the color buffer in step 830. If a virtual shadow is to be added where there is no virtual object, then the pixels of opacity filter 114 that correspond to the location of the virtual shadow are darkened in step 834.

In conjunction with a rendered image, the hub computing system may also provide audio over the speakers 22 (FIG. 1). The audio may be associated with a scene in general. Alternatively or additionally, the audio may be associated with a specific virtual object. Where associated with a specific virtual object, the audio may have a directional component. Thus, where two users are viewing a virtual object having associated audio, the object being to the left of a first user and to the right of the second user, the corresponding audio will appear to come from the left of the first user and to the right of the second user. This effect may be generated by spatially separated speakers 22. While FIG. 1 shows two speakers 22, there may be more than two speakers in further embodiments.

Returning to FIG. 9, in step 650, the processing unit checks whether it is time to send a rendered image to the head mounted display device 2, or whether there is still time for further refinement of the image using more recent position feedback data from the hub 12 and/or head mounted display device 2. In a system using a 60 Hertz frame refresh rate, a single frame is about 16 ms.

In particular, the composite image based on the z-buffer and color buffer (described above with respect to FIGS. 13 and 13A) is sent to microdisplay 120. That is, the images for the one or more virtual display slates 460 are sent to microdisplay 120 to be displayed at the appropriate pixels, accounting for perspective and occlusions. At this time, the control data for the opacity filter is also transmitted from processing unit 4 to head mounted display device 2 to control opacity filter 114. The head mounted display would then display the image to the user in step 658.

On the other hand, where it is not yet time to send a frame of image data to be displayed in step 650, the processing unit may loop back for more updated data to further refine the predictions of the final FOV and the final positions of objects in the FOV. In particular, if there is still time in step 650, the processing unit 4 may return to step 608 to get more recent sensor data from the hub 12, and may return to step 656 to get more recent sensor data from the head mounted display device 2.

The processing steps 630 through 652 are described above by way of example only. It is understood that one or more of these steps may be omitted in further embodiments, the steps may be performed in differing order, or additional steps may be added.

Moreover, the flowchart of the processor unit steps in FIG. 9 shows all data from the hub 12 and head mounted display device 2 being cyclically provided to the processing unit 4 at the single step 634. However, it is understood that the processing unit 4 may receive data updates from the different sensors of the hub 12 and head mounted display device 2 asynchronously at different times. The head mounted display device 2 provides image data from cameras 112 and inertial data from IMU 132. Sampling of data from these sensors may occur at different rates and may be sent to the processing unit 4 at different times. Similarly, processed data from the hub 12 may be sent to the processing unit 4 at a time and with a periodicity that is different than data from both the cameras 112 and IMU 132. In general, the processing unit 4 may asynchronously receive updated data multiple times from the hub 12 and head mounted display device 2 during a frame. As the processing unit cycles through its steps, it uses the most recent data it has received when extrapolating the final predictions of FOV and object positions.

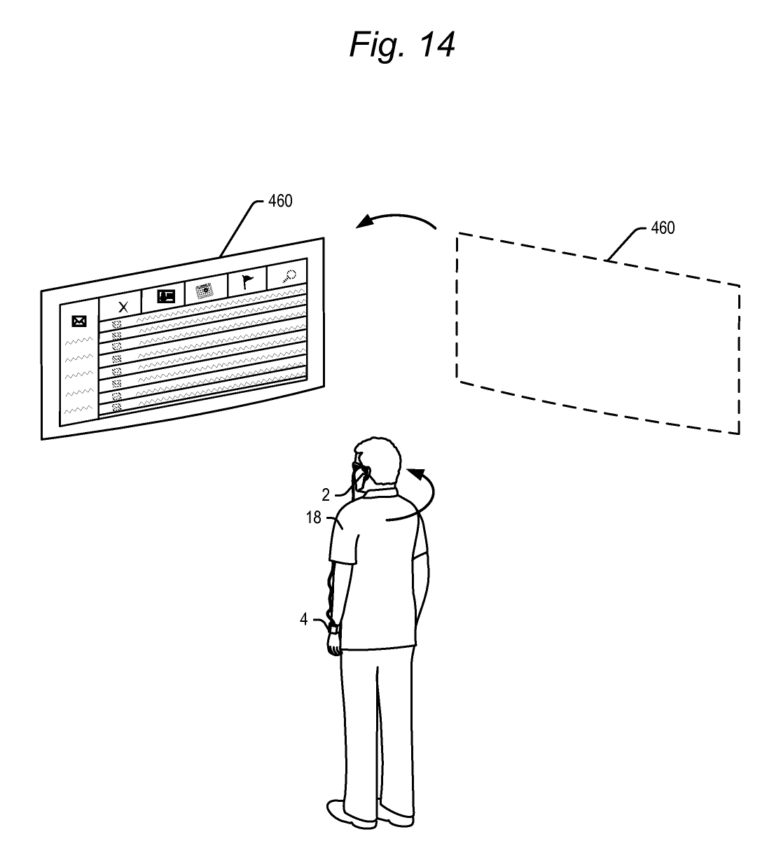

FIG. 14 shows a mixed reality environment similar to that shown in FIG. 8. In this example, the user 18 has selected the virtual display slate 460 including content 462, which in this non-limiting example is an email application. However, in FIG. 14, the user has turned his head to change the FOV. In accordance with the present technology, the virtual display slate 460 has moved with the user so that it remains fixed and easily accessible within the user's FOV. Had the user also selected virtual display slates 462a and/or 462b from FIG. 8, those slates would have moved with the user so as to remain accessible for interaction as well. As noted above, the position of the virtual display slate may be updated several times a second, and the virtual display slate 460 may be displayed in several intermediate positions between the position shown in FIG. 8 and the position shown in FIG. 14.

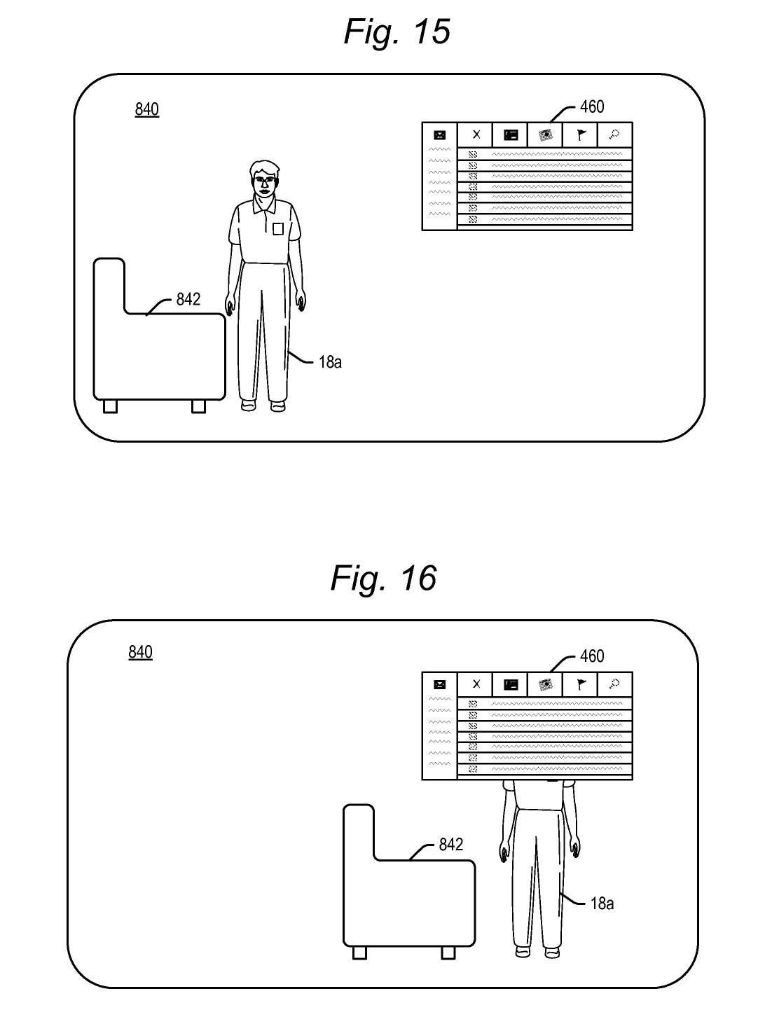

FIGS. 15 and 16 are illustrations of a FOV 840 seen through a head mounted display device 2 of a user 18 (not shown); that is, FIGS. 15 and 16 are sample illustrations of what a user (not shown) may see through a head mounted display device 2. The FOV 840 includes an actual direct view of real world objects, including another user 18a and a chair 842 (which may be real or virtual). The FOV 840 further includes a display of a virtual image in the form of a virtual display slate 460, showing the same content 462 as described above. In FIG. 16, the user 18 not shown has panned his view to the left relative to the view of FIG. 15. Accordingly, the user 18a and chair 842 have shifted to the right within the user's FOV. However, the position of the virtual object 460 has remained fixed and easily accessible to the user 18 within the user's FOV.

Where a scene contains more than one user 18, only one user can control a given dynamic virtual object at a time, though it is conceivable that control of a given dynamic virtual object may switch off between users. In FIGS. 15 and 16, the virtual display slate 460 is controlled by the user 18 not shown. It is conceivable that the user 18a shown in FIGS. 15 and 16 sees the virtual display slate 460, but the user 18a would see the back of display slate 460. The back may appear as a blank slate, or some other appearance of the back of a three-dimensional virtual display slate. In alternative embodiments, the user 18a would not see the virtual display slate 460 at all.

In embodiments, a selected virtual object faces a user and easily accessible to the user for interaction. However, a user may de-select a virtual object such as a virtual display slate 460. In such instances, a user may still interact with that virtual object, but the virtual object may not move with the user. The user may be able to walk around back of the virtual object, and see a blank slate, or some other appearance of the back of a three-dimensional virtual display slate.

In embodiments above, when an object is selected, it may be facing a user and interacted with. However, in embodiments, a user may perform a predefined deactivation gesture indicating that interaction with the selected virtual object not be allowed until a further predefined activation gesture be performed. This can be useful in preventing inadvertent interaction with a virtual object. Moreover, where a virtual object is not selected, it may be that the user may only interact with that virtual object when the user is at a predefined position relative to the virtual object, for example in front of the object, or off to the side by not more than a predefined angle. This again may prevent inadvertent interaction with the virtual object.

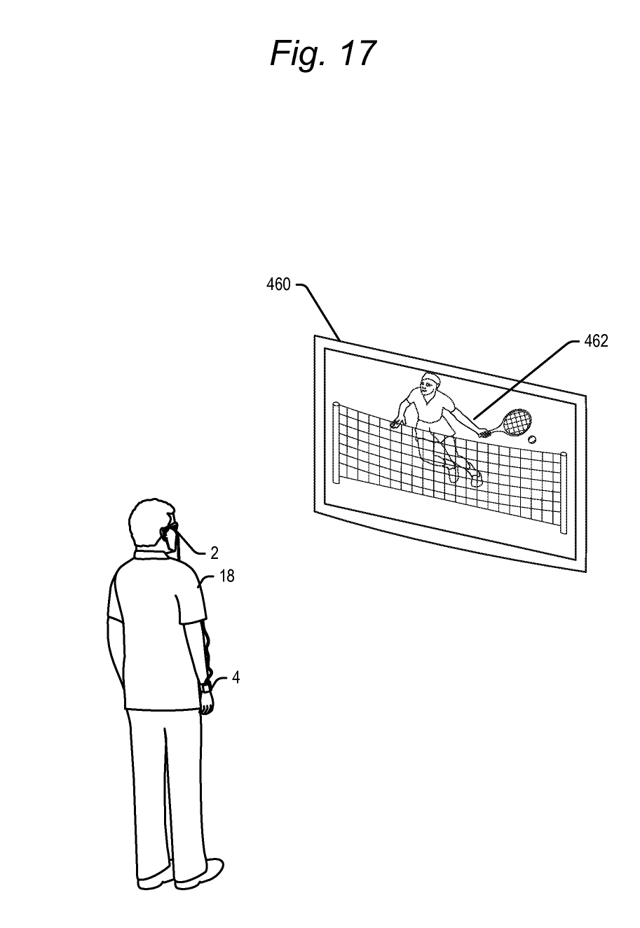

FIG. 17 illustrates a mixed reality environment where a user 18 is viewing video content 462 on virtual display slate 460. It is understood that the video content may be shown in two-dimensions, or three-dimensions to produce a stereoscopic viewing experience. Where stereoscopic, the separation distance between the two video feeds may be altered and optimized based on the distance of the virtual display slate 460 from the user 18. Where the virtual display slate 460 is relatively close, the offset of the video feeds may be relatively small compared to the same stereoscopic display positioned farther from the user. This can reduce eye strain. Moreover, the present system can measure interocular distance for each user, which may be different for different users. Thus, the present system can optimize a stereoscopic effect for each user differently, depending on their specific measured interocular distance.

Additionally, sitting too close to a stereoscopic video can produce eye strain. In embodiments, when the slate 460 displaying stereoscopic content is closer than the predefined distance, the stereoscopic effect may be disabled so that the video is shown in two dimensions.

It may happen that a virtual display slate 460 is positioned close to a user, or otherwise made to be a large size so that it dominates a user's FOV. In embodiments, the hub 12 and/or processing unit 4 can sense when a virtual display slate 460 takes up more than a predefined portion of the overall FOV. In this instance, the hub 12 and/or processing unit 4 can decrease the opacity (decrease the alpha value as discussed above) of the slate 460 so that the user can see the virtual display slate 460 and content 462, but can also see through the slate 460 to real world and/or virtual objects behind the slate 460. This may be useful when standing in a still position, but may also be useful when moving (e.g., walking or driving in a car) to see objects in the user's path. This embodiment may be used when the slate is large in the FOV as described above. Alternatively, it may be used when the slate is any size relative to the overall FOV.

As noted, embodiments of the present technology position virtual objects so that they are easily accessible for interaction as a user moves around within a mixed reality environment. However, even with this, it may happen that certain interactive elements of a virtual object are to the edge of a user's FOV. In a further aspect of the present technology, the system may infer that a user is not interacting with these peripheral interactive elements, and the system can “fade” these peripheral interactive element; i.e., make them less opaque (decrease alpha value) or otherwise visually mute them. When a user indicates a desire to interact with these elements, for example by looking at them or hand-gesturing toward them, them may again become prominent.

In a further embodiment, it is contemplated that areas of the virtual display slate or other selected virtual object on which the user is focused may be made brighter. In effect, it may appear to the user as if the user is wearing a head light, illuminating areas of focus to a greater degree than areas outside of the user's focus. These areas of greater illumination may be in the center of the user's FOV, but may be off to one side, or above or below, the center in further embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a mixed reality experience to one or more users, the system comprising:
one or more display devices for the one or more users, each display device including a display unit for displaying a virtual image to the user of the display device; and
a computing system operatively coupled to the one or more display devices, the computing system generating the virtual image for display on the one or more display devices, the computing system displaying the virtual image to a user of the one or more users at positions where the virtual object remains accessible to the user for interaction with the virtual object by the user as the user's head position changes.

2. The system of claim 1, the computing system comprises at least one of a hub computing system and one or more processing units.

3. The system of claim 1, the computing system displays the virtual object at a fixed distance from the user within the user's field of view as the user's head position changes.

4. The system of claim 1, the computing system displays the virtual object at a fixed rotational orientation with respect to the user within the user's field of view as the user's head position changes.

5. The system of claim 1, the virtual object is displayed at a fixed rotational orientation with respect to the user's face.

6. The system of claim 1, the virtual object is displayed at a fixed rotational orientation with respect to the user's eyes.

7. The system of claim 1, wherein the virtual object remains accessible to the user upon the user selecting the virtual object for interaction with the virtual object.

8. The system of claim 7, wherein the virtual object is selected by the user performing a gesture with the user's hands, body or eyes.

9. The system of claim 1, wherein the computing system allows a user to select the virtual object, and move the virtual object to a new position in three dimensional space with a gesture.

10. A system for presenting a mixed reality experience to a user, the system comprising:
a display device for the user, the display device including a first set of sensors for sensing data relating to a position of the display device and a display unit for displaying a virtual image to the user of the display device; and
a computing system operatively coupled to the display device, the computing system including a second set of sensors for sensing data relating to a position of the user, and the computing system generating the virtual image for display on the display device, the computing system displaying the virtual image to the user at positions in three-dimensional space that, over a predetermined period of time, average to a constant position within the user's field of view as the user moves.

11. The system of claim 10, wherein the virtual object is a virtual display slate.

12. The system of claim 11, wherein the computing system displays at least one of one of static and dynamic images on the virtual display slate.

13. The system of claim 12, wherein the computing system displays stereoscopic images on the virtual display slate.

14. The system of claim 13, wherein the computing system displays different offsets to video streams forming the stereoscopic images depending on at least one of: i) a distance of the virtual display slate from the user; and ii) a measured interocular distance of the user.

15. The system of claim 13, wherein the computing system changes display of the content on the virtual display slate from stereoscopic to two-dimensional when the virtual display slate is less than a predefined distance away from the user.

16. The system of claim 11, wherein the computing system varies an opacity of the virtual display screen, depending on at least one of: i) how much of the field of view is taken up by the virtual display screen, and ii) a rate of speed with which a user is moving.

17. A method of presenting a mixed reality experience to one or more users, the method comprising:
(a) displaying a static virtual object to a user at a first position in the user's field of view;
(b) displaying a dynamic virtual object to the user at a second position in the user's field of view;
(c) displaying the static virtual object to the user at a third position in the user's field of view upon movement of the user; and
(d) displaying the dynamic virtual object to the user at the second position in the user's field of view of said step (b) upon the movement of the user in said step (c).

18. The method of claim 17, wherein the dynamic virtual object remains in said second position in the user's field of view, and in the same size in the user's field of view, unless at least one of a position and size of the dynamic virtual object are changed by the user.

19. The method of claim 17, wherein the dynamic virtual object is a virtual display slate, the virtual display slate remaining orthogonal to a vector from the user to the virtual display slate upon movement of the user in said step (c).

20. The method of claim 17, wherein said step (d) of displaying the dynamic virtual object to the user at the second position upon the movement of the user occurs after selection of the dynamic virtual object, further comprising the steps of:
(e) receiving a gesture deselecting the dynamic virtual object after the user movement in said step (c); and
(f) displaying the dynamic virtual object to the user at the fourth position in the user's field of view, different than the second position in the user's field of view, upon movement of the user after deselection of the dynamic virtual object in said step (e).
